(19) United States
(12) Patent Application Publication
(10) Pub. No.: US 2020/0255079 A1
(43) Pub. Date: Aug. 13, 2020

(54) Bicycle Saddle

(71) Applicant: Ergon International GmbH, Koblenz (DE)

(72) Inventors: Andreas KRAUSE, Koblenz (DE); Franc ARNOLD, Koblenz (DE)

(21) Appl. No.: 16/327,506

(22) PCT Filed: Aug. 8, 2017
(86) PCT No.: PCT/EP2017/070041

§ 371 Date: Feb. 22, 2019

(30) Foreign Application Priority Data
Aug. 24, 2016 (DE) 20 2016 005 103.3
Feb. 3, 2017 (DE) 20 2017 000 579.4

(51) Int. Cl. B62J 1/18

(52) U.S. Cl. CPC B62J 1/18

(57) ABSTRACT

A bicycle saddle having a saddle shell, on the bottom side of which a saddle frame is arranged. A saddle cushion is provided on a top side of the saddle shell. For improved comfort, the saddle cushion laterally protrudes beyond the saddle shell at least in the seat region.

The invention relates to a bicycle saddle.

Bicycle saddles comprise a saddle shell usually made of hard plastic material. The bottom side of the saddle shell is connected with a saddle frame. The saddle frame is usually connected with a rear portion of the saddle shell and with the saddle tip. The saddle frame is usually connected with the seat post via a clamping element, which seat posit is clampingly retained in the seat tube of the bicycle frame. A saddle cushion is arranged on an upper side of the saddle shell.

A variety of saddles for improving comfort exists on the market, which e.g. comprise specially designed seat cushions with gel inserts. Further, it is known to provide damping elements between the bottom side of the saddle shells and the saddle frame for the purpose of improving comfort. However, bicycle saddles with improved sitting comfort are most often relatively heavy.

It is an object of the present invention to provide a bicycle saddle with good comfort characteristics.

The object is achieved, according to the invention, with a bicycle saddle as recited in claim 1.

The bicycle saddle of the invention comprises a saddle shell whose bottom side is connected with a saddle frame and whose upper side is connected with a seat cushion. According to the invention, the seat cushion is designed such that protrudes laterally beyond the saddle shell in at least a seat region of the saddle shell. The seat region of the saddle shell is the enlarged rear region of the saddle in which the seat bones of the user are situated. Due to the lateral protrusion of the seat cushion provided by the invention, the compliance of the saddle is improved in this region. The dynamics occurring during pedaling can thus be absorbed well by the saddle. The protruding region of the seat cushion has the advantage that a good damping is still realized, while, due to the possibility of this part of the seat cushion being bent or moved, the comfort is improved.

In a preferred embodiment of the bicycle saddle of the invention, the seat cushion protrudes laterally beyond the saddle shell not only in the seat region, but also in the region of the saddle tip and/or a center region of the saddle shell. Here, the saddle tip is the front region of the saddle, seen in the traveling direction, and the center region is the transition region between the seat region and the region of the saddle tip. It is particularly preferred that the corresponding protrusion of the seat cushion is provided along the entire circumference of the saddle shell. Thereby, an improvement in sitting comfort is achieved in different sitting positions. In addition, the manufacture of the seat cushion is simplified, in particular for a seat cushion that protrudes laterally all along the circumference of the saddle shell.

The protrusion of the seat cushion with respect to the outer edge of the saddle shell is preferably larger than 10 mm and in particular larger than 15 mm. In particular, the protrusion may be more than 30 mm, more than 40 mm or more than 50 mm, if so desired. The protrusion is measured in the horizontal direction with the saddle in the mounted state. Possibly, the protrusion may differ in individual regions of the saddle. In particular in the seat region it is preferred to provide a larger protrusion than in the region of the saddle tip.

Further, it is preferred that the saddle shell has a downward directed edge. In the mounted state, the edge thus is directed downward or towards the saddle frame. A rigidifying of the saddle shell is achieved by such a downward directed edge. Thus, it is possible e.g. to manufacture a saddle shell from a more elastic and/or thinner material, while retaining the same rigidity. It is preferred that the edge extends circumferentially. Possibly, such an edge may be provided only in partial regions. In this respect, it is preferred to provide such an edge in particular in the seat region on both sides of the saddle shell, since the load on the saddle shell is the highest in this region.

It is further preferred that the edge has a height of more than 3 mm, in particular more than 5 mm and, particularly preferred, more than 7 mm. Even in case of a circumferentially extending edge, the height of the edge does not have a continuous height throughout. Moreover, it is preferred that the edge is higher in the seat region that e.g. in the region of the saddle tip.

Preferably, the saddle shell and the edge provided at the outer edge of the saddle shell are formed integrally.

In a particularly preferred embodiment of the invention, the seat cushion comprises an extension that is directed downward and preferably formed integrally with the seat cushion. The extension is preferably arranged laterally beside the edge. If an edge is provided, the extension covers the same preferably completely in side view. In this respect, the extension preferably has a height at least corresponding to the height of the edge in the corresponding region. If no saddle shell with a circumferential edge is provided, the corresponding extension may also be provided in regions in which no edge is provided at the saddle shell. By providing at least one corresponding extension, the comfort of the saddle can be improved further.

Moreover, it is preferred that the extension has a width that corresponds to the width of the protrusion. In this respect, it is preferred that an inner side of the extension rests on an outer side of the edge of the saddle shell, if such an edge is provided. An outer side of the extension is flush with the outer side of the seat cushion in side view. For changing the characteristics of the seat cushion in individual regions, it is also possible that the extension contacts the existing edged only in sections and, for the rest, is spaced from the edge, or that a corresponding recess is provided between the extension and the edge. Thereby, a greater elasticity is realized.

In a horizontal design, the extension has a width, corresponding to the protrusion of the seat cushion, of at least 10 mm, preferably at least 15 mm and in particular at least more than 30 mm. Extensions having a width of more than 40 mm and even more than 50 mm are possible. The width of the extension is the width corresponding to the protrusion measured in the horizontal direction in the mounted state of the saddle.

Due to the protrusion or extension preferred according to the invention which in particular is as large as possible, the elasticity or compliance of the saddle is improved in the corresponding region. In this respect, a corresponding protrusion or extension is particularly preferred in the seat region. Due to the material of the seat cushion, a restoring force is generated in addition to the increased elasticity and deformability.

The seat cushion preferably includes thermoplastic elastomers (TPE). Preferably, foams are used, such as PU foams. In particular, closed-cell foams are preferred. The seat cushion in particular includes TPU (thermoplastic polyurethane) and, as is particularly preferred, is made from this material. The material produced by BASF under the product name “Infinergy” is particularly suited for this purpose. Methods for producing TPU are described e.g. in EP 692 510, WO 00/44821, EP 11 74 459 and EP 11 74 458. Further, it is preferred that the seat cushion is made from EVA (ethylene vinyl acetate) or includes EVA. Further, EPP (expanded polypropylene) and EPE (expanded polyethylene) may be used as materials. A combination of these materials or a combination of these materials with other materials is also possible, e.g. in a multi-layered structure. In particular, mixtures with co- or terpolymers may also be used. Thereby, different damping and movement characteristics of the seat cushion can be obtained. It is also possible to provide a higher compaction of the corresponding materials in different regions, so that the damping and movement characteristics can be influenced thereby.

Moreover, a thermoplastic elastomeric spherical foam is suited as a material for the seat cushion. Such a foam is offered by Sekisui under the product name “ELASTIL”. In particular, this is a closed-cell foam. In a preferred embodiment, according to the invention, the seat cushion comprises a thermoplastic elastomeric spherical foam, such as in particular Elastil, or is made from the same. A combination with the other materials described, which are suitable for forming the seat cushion, is also possible.

Another well suited material for forming the seat cushion is a polyester-based PU material. In this respect, the material offered by BASF under the product name “Elastopan” is particularly suited. Preferably, the seat cushion includes such a material or is made therefrom, while it is again possible to combine this material with other materials described.

It is particularly preferred that the seat cushion includes one or a plurality of particulate foams and is, in particular, made from one or a plurality of particulate foams. As a base material, E-PTU, EPP, EPS, EPE or similar foams are particularly preferred. Generally, particulate foams are formed by small spheres of the expanded base material. These particles formed as spheres or other bodies are given their final shape in a tool, such as a mold or the like, using temperature and, possibly, water vapor. In particular, particulate foams have the advantage that they have a low density, a good heat/cold insulation and good damping characteristics.

Manufacturing the seat cushion from the above mentioned preferred materials, in particular thermoplastic polyurethane, such as particularly preferred the material Infinergy, as well as preferably also the materials Elastil and/or Elastopan, in particular has the advantage that no saddle cover has to be provided which spans the seat cushion. Such covers that entirely enclose the seat cushion and are fastened to the saddle shell at the bottom side or in the edge region thereof, are required when conventional foams are used, since their stability is insufficient. When using the above materials, such a seat cover is not required, since these materials, specifically the materials Infinergy and/or Elastil and/or Elastopan, have a sufficiently high stability.

Therefore, it is preferred that at least partial regions of the seat cushion have no saddle cover or seat cover. In particular those regions that are made from the above described preferred materials have no corresponding cover. Preferably, no cover is provided. Thus, the seat cushion directly forms the exposed or visible surface on which the user sits.

The use of TPU has the particular advantage that it provides for a good compliance, while at the same time a good restoring force (rebound behavior) is provided. Further, TPU can be connected well with the upper side of the saddle shell. Before being processed, TPU is present in a spherical shape and is subjected to hot vapor flowing through it to manufacture the seat cushion. For an improved connection between the seat cushion and the upper side of the saddle shell, it is particularly preferred that the TPU raw material is already arranged on the saddle shell and is subjected to vapor thereafter. Thereby, a direct connection between the seat cushion and the upper side of the saddle shell can be achieved. Here, the TPU raw material is placed in a corresponding form in particular together with the saddle shell, and is subjected to vapor thereafter. Further, it is particularly preferred that the saddle shell has passage openings. In particular, these are in particular cylindrical openings regularly distributed across the entire saddle shell. Thereby, it is possible to perform the application of vapor to the TPU raw material through the saddle shell, i.e. from an inner or bottom side of the saddle shell. The connection between the TPU and the upper side of the saddle shell is further improved thereby.

In a preferred embodiment, the material used for the seat cushion has a good resilience. Besides TPU, TPU foams and/or EVA foams are also suitable for manufacturing the seat cushion. The rebound behavior of the seat cushion preferably is in a range of preferably more than 30%, in particular more than 40% and particularly preferred more than 50%.

In particular in a seat region of the saddle, the seat cushion has an elasticity module of 0.1 to 10 MPa, in particular 0.1 to 5 MPa and particularly preferred 0.1 to 1.0 MPa. The particularly preferred material Infinergy E-TPU has a modulus of elasticity between 0.1 and 0.5 MPa.

Further, it is particularly preferred that the seat cushion has a low weight due to its low density. Specifically, the elastomeric body has a density of less than 1 g/cm³, particularly preferred less than 0.5 g/cm³, and in particular less than 0.2 g/cm³. One of the particularly preferred materials, the material Elastil, has a density in a range from 0.05 to 0.2 g/cm³.

An upper side of the seat cushion may be provided with a cover layer at least in part. Here, the cushion may be spanned with a cover layer. Likewise, a cover layer or parts of a cover layer may be connected with the seat cushion by gluing or vapor deposition. The corresponding cover layer is e.g. provided preferably on extensions of the seat cushion in the center portion of the saddle, since, in this region, the saddle is contact with the inner side of the thigh and the inner side of the thigh rubs against the saddle in this region.

The invention will be explained in more detail hereinafter with reference to a preferred embodiment and to the accompanying drawings.

In the Figures:

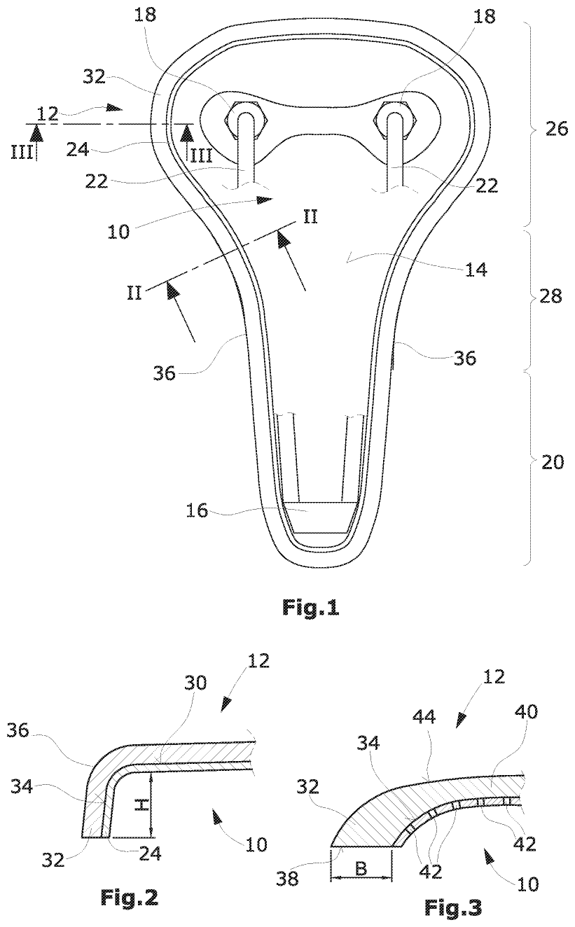

FIG. 1 is a schematic bottom view of a preferred embodiment of a saddle according to the invention,

FIG. 2 is a schematic sectional view along line II-II in FIG. 1, and

FIG. 3 is a schematic sectional view along line iii-iii in FIG. 1.

An embodiment of a saddle according to the invention has a saddle shell 10 covered by a cushion 12. On a bottom side 14 of the saddle shell 10 receiving elements 16, 18 are arranged which are connected with the saddle shell that, in particular, is formed integrally from plastic material. The receiving element 16 arranged in the region of a saddle tip 2, as well as the receiving elements 18 arranged rearward, seen in the traveling direction, serve for connection with a saddle frame 22 illustrated only in part in FIG. 1.

In the embodiment illustrated, the saddle shell 10 has a circumferential edge 24 directed downward in the mounted state. The same extends along the outer edge of the saddle shell 10. In the embodiment illustrated, the edge 24 is thus arranged in a rear seat portion 26, a center portion 28 and the region of the saddle tip 20.

The seat cushion 12 covers the upper side 30 of the saddle shell 10 on the one hand and, in addition, is arranged laterally beside the edge 24 of the saddle shell 10. For this purpose, the seat cushion 12 has an extension 32 formed integrally with the seat cushion. In the embodiment illustrated, the extension extends entirely around the saddle shell and in particular is always in contact with an outer side 34 of the edge 24.

The edge 24 is directed downward, i.e. away from the bottom side 14 of the saddle shell 10. The edge 24 has a height H of in particular at least 3 mm, preferably 5 mm and particularly preferred 7 mm. In the embodiment illustrated, the extension 32 of the seat cushion has the same dimension, so that the extension 32 completely covers the edge 24 laterally.

Further, the seat cushion 12 may be completely or partly provided with a cover layer. In the embodiment illustrated, a cover layer 36 is arranged in the center region 28, so as to reduce in particular the friction at the inner side of the thighs.

FIG. 3 shows a schematic section in the seat portion 26. Similar to the region illustrated in FIG. 2, the seat cushion 12, which is made in particular from TPU, has an extension 32. On its bottom side 38 directed downward in the mounted state, the extension has a horizontal width B of at least 10 mm. Widths of at least 15 mm, at least 30 mm, at least 40 mm and at least 50 mm are preferred. The seat cushion 12 becomes thinner towards the inner side in the direction of a region 40 in which the user sits. When loaded, restoring and gravitational forces are generated in the extension 32, which can be absorbed well in particular by the preferred seat cushion material TPU.

In a preferred embodiment, the saddle shell 10 has passage openings 42 in particular over its entire area. These serve for manufacturing the saddle by application of vapor to TPU raw material for forming the seat cushion 12. With this manufacturing process a very good connection can be achieved between the seat cushion 12 and the top side 34 of the saddle shell 10.

In particular, if the seat cushion 12 is a seat cushion of a material preferred according to the invention, such as Infinergy, Elastil and/or Elastopoan, no cover is provided on the upper side 44 of the seat cushion 12, or is provided only in a partial region, as explained with reference to FIG. 2. Thus, the user sits in particular on the exposed or visible surface 44 of the seat cushion 12.

1. A bicycle saddle comprising:
a saddle shell,
a saddle frame connected with a bottom side of the saddle shell, and
a seat cushion connected with an upper side of the saddle shell,
wherein
at least in a scat region of the saddle shell, the seat cushion protrudes laterally beyond the saddle shell.

2. The bicycle saddle of claim 1, wherein at least in a region of a saddle tip of the saddle shell, the seat cushion protrudes laterally beyond the saddle shell.

3. The bicycle saddle of claim 1, wherein the seat cushion protrudes laterally at least in a center region of the saddle shell.

4. The bicycle saddle of claim 1, wherein the seal cushion protrudes laterally along an entire circumference of the saddle shell.

5. The bicycle saddle of claim 1, wherein in individual regions, the protrusion of the seat cushion is at least 10 mm.

6. The bicycle saddle of claim 1, wherein the saddle shell has a downward directed edge.

7. The bicycle saddle of claim 6, wherein the downward directed edge is provided in at least one of the seat region, the center region, the region of the saddle tip, and along the entire circumference of the saddle shell.

8. The bicycle saddle of claim 6, wherein the edge has a height of at least 3 mm.

9. The bicycle saddle of claim 1, wherein the seat cushion has a downward directed extension arranged laterally beside the downward directed edge.

10. The bicycle saddle of claim 9, wherein the downward directed extension has a width of at least 10 mm.

11. The bicycle saddle of claim 1, wherein a cover layer is provided on at least a part of an upper side of the seat cushion.

12. The bicycle saddle of claim 1, wherein the seat cushion is made from expanded TPU or includes TPU.

13. The bicycle saddle of claim 1, wherein the seat cushion is made from EPP or includes EPP.

14. The bicycle saddle of claim 1, wherein an upper side of the seat cushion is at least partly uncovered or exposed.
